(19) United States
(12) Patent Application Publication
(10) Pub. No.: US 2025/0256918 A1
(43) Pub. Date: Aug. 14, 2025

(54) REFUSE LOADING MECHANISM WITH FLEXIBLE MEMBER

(71) Applicant: The Heil Co., Chattanooga, TN (US)

(72) Inventor: Ethan Lee Maness, Rainsville, AL (US)

(21) Appl. No.: 19/044,995

(22) Filed: Feb. 4, 2025

Related U.S. Application Data
(60) Provisional application No. 63/552,294, filed on Feb. 12, 2024.

(51) Int. Cl. B65F 3/02

(52) U.S. Cl. CPC B65F 3/02; B65F 2003/0253

(57) ABSTRACT

A refuse collection system includes a refuse-receiving container and a refuse loading mechanism. The refuse loading mechanism is coupled to the refuse-receiving container and transfers refuse into the refuse-receiving container. The refuse loading mechanism includes a guide assembly, a flexible member coupled to the guide assembly, a reciprocating member, a rotatable element, and a drive unit. The flexible member is coupled to the guide assembly at a first location and a second location. The reciprocating member translates relative to the guide assembly. The rotatable element is coupled to the reciprocating member and engaged with the flexible member. The drive unit turns the rotatable element on the flexible member such that the reciprocating member translates on the guide assembly.

### CROSS-REFERENCE TO RELATED APPLICATION

This application claims the benefit under 35 U.S.C. § 119 (c) of U.S. Patent Application No. 63/552,294, entitled “Refuse Loading Mechanism With Flexible Member,” filed Feb. 12, 2024, which is incorporated herein by reference in its entirety.

### BACKGROUND

Refuse collection vehicles are typically used to pick up quantities of refuse for hauling to a determined area, such as a landfill, transfer station, or material recovery facility. Refuse collection vehicles are sometimes modified to collect recyclables or other materials for transport.

Some refuse collection systems use large trucks having compaction capabilities, extending their effective range and capacity between unloadings. The refuse collection vehicles can include collection/intermediate containers (or “cans”). The intermediate container allows a refuse vehicle designed for the collection of large waste containers, such as dumpsters, to collect smaller, non-commercial waste containers.

### SUMMARY

Implementations of the present disclosure are generally directed to refuse handling mechanisms for refuse collection vehicles and methods of operating such systems.

In a general aspect of the disclosure, a refuse collection system includes a refuse-receiving container and a refuse loading mechanism coupled to the refuse-receiving container. The refuse loading mechanism is configured to transfer refuse into the refuse-receiving container. The refuse loading mechanism includes a guide assembly, a flexible member, a reciprocating member, a rotatable element, and a drive unit. The flexible member is coupled to the guide assembly at a first location and a second location. The reciprocating member is configured to translate relative to the guide assembly. The rotatable element is coupled to the reciprocating member and engaged with the flexible member. The drive unit is configured to turn the rotatable element on the flexible member such that the reciprocating member translates on the guide assembly.

In some implementations, a grabber device coupled to the reciprocating member.

In some implementations, the drive unit is configured to move the reciprocating member between a retracted position and at least one other position.

In some implementations, wherein the drive unit includes an electric motor.

In some implementations, the drive unit includes a hydraulic motor.

the reciprocating member includes a slide member configured to move in and out relative to the guide assembly.

In some implementations, the flexible member includes a belt.

In some implementations, the flexible member includes a belt, wherein the rotatable element is configured to engage the belt.

In some implementations, the rotatable element includes two or more teeth configured to engage the flexible member.

In some implementations, the guide assembly includes one or more tracks, and the reciprocating member includes a slider beam configured to translate on the track.

In some implementations, the guide assembly includes one or more rollers, and the reciprocating member is configured to translate on at least one of the one or more rollers.

In some implementations, the refuse collection system further includes one or more guides configured to guide the flexible member.

In some implementations, the one or more guides include one or more idlers. The idlers are configured to guide the flexible member to promote engagement of the belt with the rotatable element.

In some implementations, the one or more guides includes a first guide configured to engage the flexible member on one side of the rotatable element and a second guide configured to engage the flexible member on the other side of the rotatable element.

In some implementations, at least one of the one or more guides includes a tensioning device.

In some implementations, the refuse collection system further includes one or more tensioning devices configurable to alter tension on the flexible member.

In some implementations, the reciprocating member is configured to translate on the guide assembly such that the rotatable element travels along the guide assembly at least a portion of the way between an extended position and a retracted position.

In some implementations, the refuse collection system further includes a grabber device coupled to the reciprocating member and including one or more arms operable to couple with a curbside container.

In some implementations, the refuse collection system further includes a grabber device coupled to the reciprocating member and including one or more electric motors operable to engage one or more arms of the grabber device with a curb-side container.

In some implementations, the refuse collection system further includes an arm coupled to the reciprocating member and operable to lift refuse toward an opening in the refuse-receiving container.

In some implementations, the refuse collection system further includes a refuse collection vehicle to which the refuse-receiving container and the refuse loading mechanism are coupled, and one or more grabber devices coupled to the reciprocating member. The one or more grabber devices are operable to collect refuse on both sides of the vehicle.

In some implementations, the guide assembly includes an upper rail and a lower support element, wherein the upper rail and the lower support element cooperate to support an overhanging load on the guide assembly.

In some implementations. the guide assembly includes an upper track and a lower support clement including one or more lower rollers. The slide assembly includes one or more upper rollers and a lower track. The upper rollers roll on the upper rail and the lower rollers roll on the lower track when the slide assembly translates on the guide assembly.

In some implementations, the refuse collection system further includes a control unit configured to operate the drive unit to move to the slider assembly in and out on the guide assembly.

In some implementations, the drive unit includes an outrunner/hub motor system. The outrunner/hub motor system is configured to turn the rotatable element on the flexible member such that the reciprocating member translates on the guide assembly.

In another general aspect of the disclosure, a refuse collection system includes a vehicle and a refuse handling mechanism coupled to the vehicle. The refuse handling mechanism is configured to handle refuse on or in the vehicle. The refuse handling mechanism includes a guide assembly, a flexible member, a reciprocating member, a rotatable element, and a drive unit. The flexible member is coupled to the guide assembly at a first location and a second location. The reciprocating member is configured to translate relative to the guide assembly. The rotatable element coupled to the reciprocating member and engaged with the flexible member. The drive unit is configured to turn the rotatable element on the flexible member such that the reciprocating member translates on the guide assembly.

In some implementations, the refuse handling mechanism is configured to load refuse onto or into the vehicle.

In some implementations, the refuse handling mechanism is configured to move refuse from one location on the vehicle to another location on the vehicle.

In some implementations, the refuse handling mechanism is configured to eject refuse from the vehicle.

In some implementations, the refuse handling mechanism is configured to compact refuse on the vehicle.

In some implementations, the flexible member is coupled to the guide assembly at a first location and a second location. The rotatable element is movable on the flexible member between the first location and the second location.

In some implementations, the drive unit includes an electric motor.

In some implementations, the flexible member includes a belt.

In another general aspect of the disclosure, a method of handling refuse on a refuse collection vehicle includes: turning a rotatable element engaged with a flexible member that is coupled to a guide assembly such that the reciprocating member translates relative to the guide assembly; and operating a refuse handling device coupled to the reciprocating member to handle refuse.

In some implementations, turning a rotatable element includes drawing the reciprocating member from a retracted position on a refuse collection vehicle to an extended position on the refuse collection vehicle.

In some implementations, turning a rotatable element includes drawing the reciprocating member from an extended position on a refuse collection vehicle to a retracted position on the refuse collection vehicle.

In some implementations, the method further includes maintaining a first portion of the flexible member at a first location relative to the guide assembly; and maintaining a second portion of the flexible member at a second location relative to the guide assembly.

In some implementations, the flexible member is coupled to the guide assembly at a first location and a second location. Turning the rotatable element includes moving the rotatable element along the flexible member between the first location and the second location.

In some implementations, operating the refuse handling device includes loading refuse into or onto the refuse collection vehicle.

In some implementations, operating the refuse handling device includes loading refuse from a curb-side container into a refuse-receiving container.

In some implementations, the method further includes moving refuse from the refuse-receiving container into another container on the refuse collection vehicle.

In some implementations, operating the refuse handling device to handle refuse includes moving refuse from one location on the vehicle to another location on the vehicle.

In some implementations, operating the refuse handling device to handle refuse includes ejecting refuse from the vehicle.

In some implementations, operating the refuse handling device to handle refuse includes compacting refuse on the vehicle.

Particular implementations of the subject matter described in this specification can be implemented so as to realize one or more of the following advantages.

Implementations of the present disclosure may reduce the need for expensive, heavy, and/or complex components with high maintenance costs.

Implementations of the present disclosure may make a refuse collection system easier to maintain.

Implementations of the present disclosure may increase reliability, sustainability, and effectiveness of a refuse collection system.

Implementations of the present disclosure may make collection of refuse more energy-efficient.

Implementations of the present disclosure may allow a refuse collection system to collect more materials.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 illustrates a refuse collection vehicle on which systems and methods as described herein can be implemented.

FIG. 2 illustrates a refuse collection system with a refuse collection mechanism and a refuse-receiving container.

FIG. 3 is a perspective view illustrating a slider assembly that reciprocates on a guide assembly.

FIG. 4 is a perspective view from below illustrating a refuse loading mechanism according to some implementations.

FIG. 5 is a perspective view illustrating a slider assembly according to some implementations.

FIG. 5 is a perspective view illustrating a slider assembly according to some implementations.

FIG. 6 is a rear view of a slider assembly the slider assembly shown in FIG. 5.

FIG. 7 illustrates is a detail view illustrating drive unit and drive pulley with the slider assembly in an extended position.

FIG. 8 illustrates a tensioning device according to implementations.

FIG. 9 illustrates another example of a tensioning device.

FIG. 10 is an end view of the refuse loading mechanism illustrating engagement of the upper and lower rollers on their corresponding tracks.

FIG. 11 illustrates a slider assembly in a retracted position in a guide assembly.

FIGS. 12A-12C are rear views of a refuse collection system illustrating use of the refuse collection system to collect refuse from a curb-side container.

FIGS. 13A-13C are top views of a refuse collection system illustrating use of the refuse collection system to grab and lift a curb-side container.

FIG. 14 illustrates a refuse loading mechanism that can load refuse on either side of a vehicle

FIG. 15 schematically illustrates a refuse loading mechanism having an outrunner/hub motor arrangement according to some implementations.

FIG. 16 depicts an example computing system, according to implementations of the present disclosure.

### DETAILED DESCRIPTION

Implementations of the present disclosure are directed to systems, devices, and methods for collecting refuse.

Some implementations include a refuse loading mechanism having a rotary drive that is attached to a reciprocating member. The rotary drive can include an electric motor. The reciprocating member can move within a guide assembly that is attached to a vehicle-mounted container. A flexible member, such as a belt, can be fixed in two spaced-apart locations on the guide assembly, and arranged to engage a rotatable element coupled to the rotary drive. The rotary drive can be operated to turn the rotatable element to move along the flexible member, which translates the reciprocating member in the guide assembly. The reciprocating member can be moved to position a refuse collecting device, such as a grabber device, to engage with a residential-sized refuse container near the vehicle. The refuse collecting device can be operated to place the contents of the residential-sized refuse container into the vehicle-mounted container.

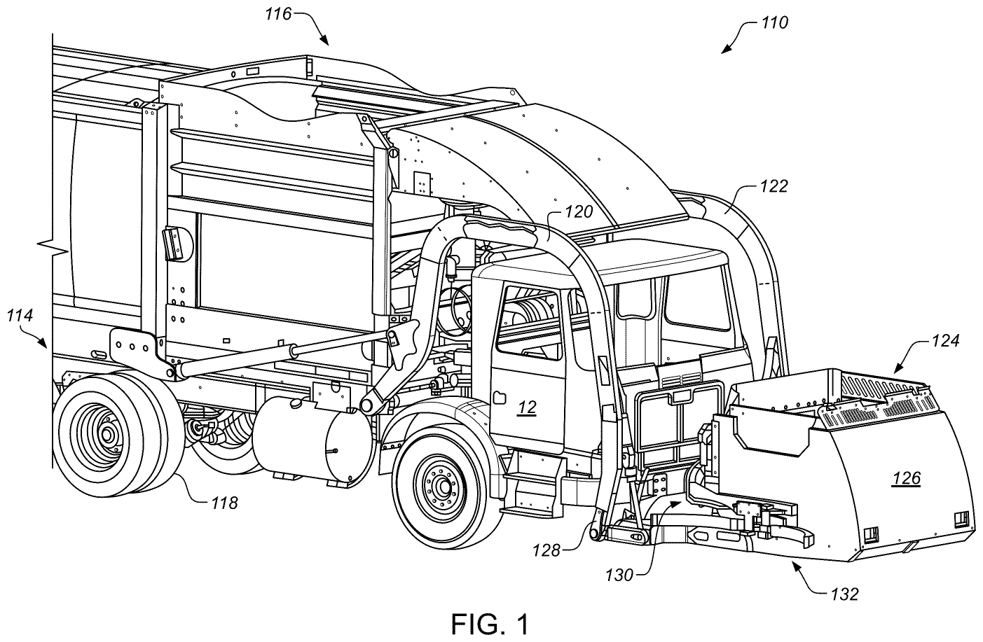

FIG. 1 illustrates a refuse collection vehicle on which systems and methods as described herein can be implemented. Refuse collection vehicle 110 includes cab 112, chassis 114, and primary container 116. A drivetrain including wheels 118 moves the refuse collection vehicle 110.

Refuse collection vehicle 110 includes a front loading arm assembly having a pair of front loading arms 120, 122. Front loading arms 120, 122 are coupled between refuse collection vehicle 110 and intermediate container 124. Intermediate container 124 includes collection bin 126.

Front-loading arms 120, 122 may have an overall U-shaped configuration. The arms may terminate at connection end 128. In some aspects, the intermediate container 124 is pivotally coupled at the connection end 128. Lift cylinders are connected between the arm bosses and the front loading arms 120, 122.

Refuse collection vehicle 110 includes refuse loading mechanism 130. Refuse loading mechanism 130 includes grabber device 132. Grabber device 132 is positioned on a side of the collection bin 126. Grabber device 132 can be operated to grab residential-sized containers (e.g., curb-side containers) and load the contents of the residential-sized container into intermediate container 124.

In some implementations, refuse loading system 130 is used to load refuse into intermediate container 124. Intermediate container 124 can be used to receive refuse from one or more curb-side containers at repeated stops along a refuse collection route. Subsequently, arms 120, 122 and container 124 can be lifted and rotated to dump the refuse that has been received into intermediate container 124 into primary container 116.

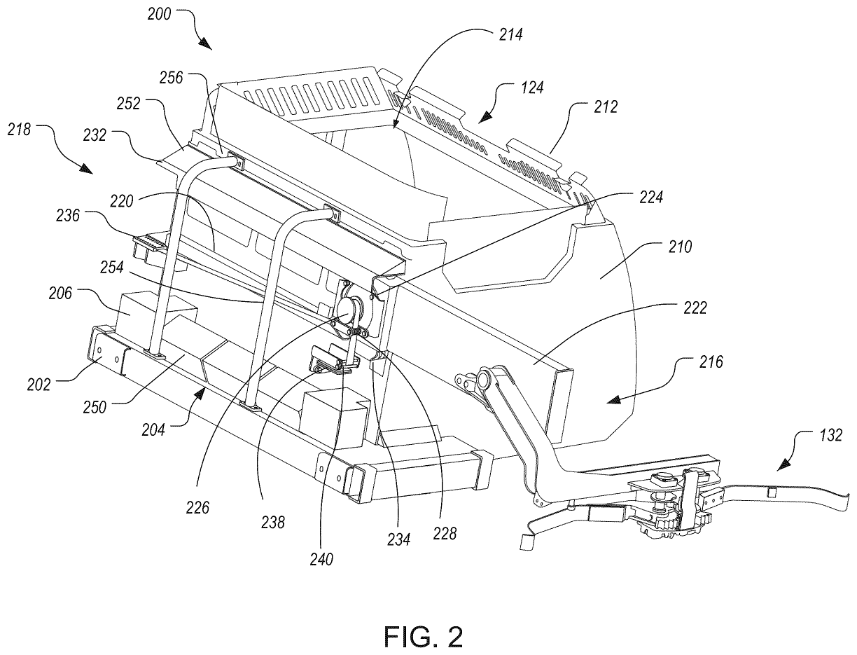

FIG. 2 illustrates a refuse collection system with a refuse collection mechanism and a refuse-receiving container. Refuse collection system 200 can be installed on a vehicle, such as refuse collection vehicle 110 described above relative to FIG. 1.

Refuse collection system 200 includes intermediate container 124, refuse loading mechanism 130, base 202, power system 204, and control unit 206. Intermediate container 124 is mounted on base 202. In some implementations, base 202 is mounted on refuse collection vehicle 110 by way a fork on a loading mechanism of the refuse collection vehicle.

Intermediate container 124 includes collection bin 210 and screens 212. Screens 212 are secured to collection bin 210 and arranged near the main opening at the top of collection bin 210. Collection bin 210 defines receiving volume 214.

Refuse loading mechanism 130 includes slider assembly 216, guide assembly 218, and belt 220. Guide assembly 218 is attached to collection bin 210 on the rear of the collection bin.

Slider assembly 216 includes slider beam 222, drive unit 224, drive pulley 226, and idler assembly 228. Grabber device 132 is mounted slider beam 222.

Guide assembly 218 includes upper rail assembly 232, lower support device 234, street-side belt attachment device 236, curb-side belt attachment device 238, and belt tensioning device 240. As used herein, a “guide assembly” includes a combination of components that define a guide, slot or passage that another component (e.g., a reciprocating member) can move through. A slot or passage for the component can be open or closed. A slot can extend over the width of a container or a portion of the container.

Power system 204 includes batteries 250. Batteries 250 are coupled to control unit 206 and drive unit 224. Control unit 206 is operable to control drive unit 224.

Upper guard 252 is provided above upper rail assembly 232. Lower guard 254 is provided below the slot for slider beam 222. Bars 256 are coupled between a rear surface of intermediate container 124 and a top surface of base 202. Bars 256 are spaced from left to right on vehicle and pass over base 202. Bars 256 can provide protection from damage to refuse loading mechanism 130.

Belt 220 is secured to street-side belt attachment device 234 at one location on refuse loading mechanism 130 and curb-side belt attachment device 236 at a second location on refuse loading mechanism 130.

In the system illustrated in FIG. 2, slider beam 222 serves as a reciprocating member for refuse loading mechanism 130. Slider beam 222, along with the other components of slider assembly 216 moves in and out on guide assembly 218, as guide assembly 218 remains fixed relative to intermediate container 124.

Drive unit 224 can be operated to turn drive pulley 226 on belt 220. As drive pulley 226 turns on belt 206, slider assembly 216 translates in and out on guide assembly 218. As slider assembly 216 moves in and out on guide assembly 218, grabber device 132 is positioned relative to the intermediate container 124 and the vehicle on which refuse collection system 200 is installed. For example, slider assembly 216 can be extended far enough from the vehicle to pick up a residential sized container and load the contents into intermediate container 124.

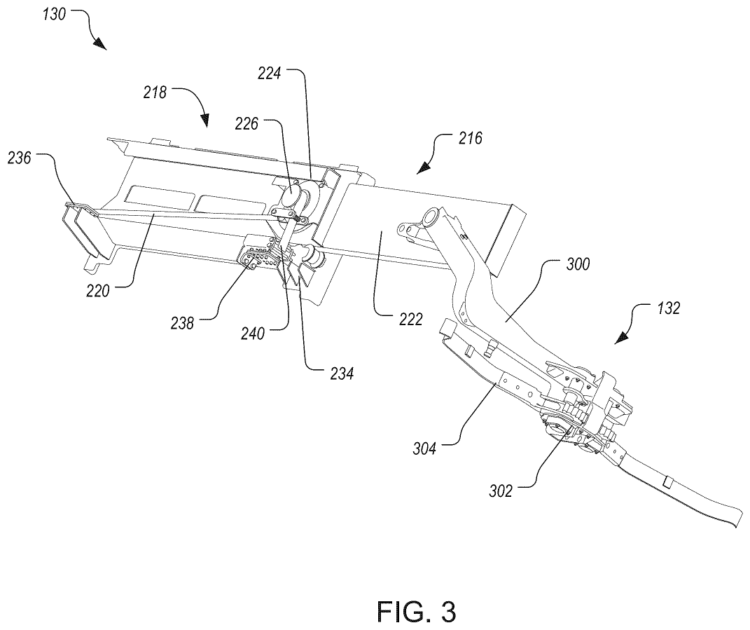

FIG. 3 is a perspective view illustrating a slider assembly that reciprocates on a guide assembly. Refuse loading mechanism 130 includes slider assembly 216, guide assembly 218, and belt 220. Slider assembly 216 includes slider beam 222, drive unit 224, drive pulley 226, and idler assembly 228. Drive unit 224 and grabber device 132 are mounted slider beam 222. Drive unit 224 can be operated to rotate drive pulley 226. Drive unit 224 can include a rotary electric motor and a gearbox. The gearbox output can be coupled to drive pulley 226. Drive unit 224 can be communicatively coupled to control unit 206. Drive pulley 226 can be turned to move across belt 220.

In the system illustrated in FIG. 3, belt 220 serves as a flexible member. In other implementations, other components can serve as a flexible member. As examples, a flexible member can be a chain, a cable, or a cord. In some implementations, a flexible member has slots, grooves, holes, or ridges for receiving or engaging with complementary elements on a rotatable element, such as teeth on a drive sprocket. In some implementations, the flexible member is a flat belt. In some implementations, the flexible member is a timing belt.

In the system illustrated in FIG. 3, drive pulley 226 serves as a rotatable element that engages on a flexible member. In other implementations, other components can serve as a rotatable element. As examples, a rotatable element can be a sprocket, a gear, or a wheel. The rotatable element can include teeth or other elements that engage on or in complementary elements of a flexible member. In implementations, the rotatable element includes a groove, such as a V-groove.

Slider beam 222 translates in guide assembly 218. In FIG. 3, slider beam 222 is in an extended position on base 202. Arm 300 of grabber device 132 can pivot (e.g. swing up and down) on slider beam 222. Grabber mechanism 302 can be operated to open and close arms 304. Arms 304 can be moved toward a closed position to grab residential-sized containers.

Grabber mechanism 302 can be electrically powered (e.g., by batteries 250 shown in FIG. 2). Grabber mechanism 302 can include electric motors to open and close the opposing arms of the grabber mechanism and/or to raise and arm 300. In some implementations, grabber mechanism 302 is communicatively coupled to a control unit (e.g., control unit 206 shown in FIG. 2).

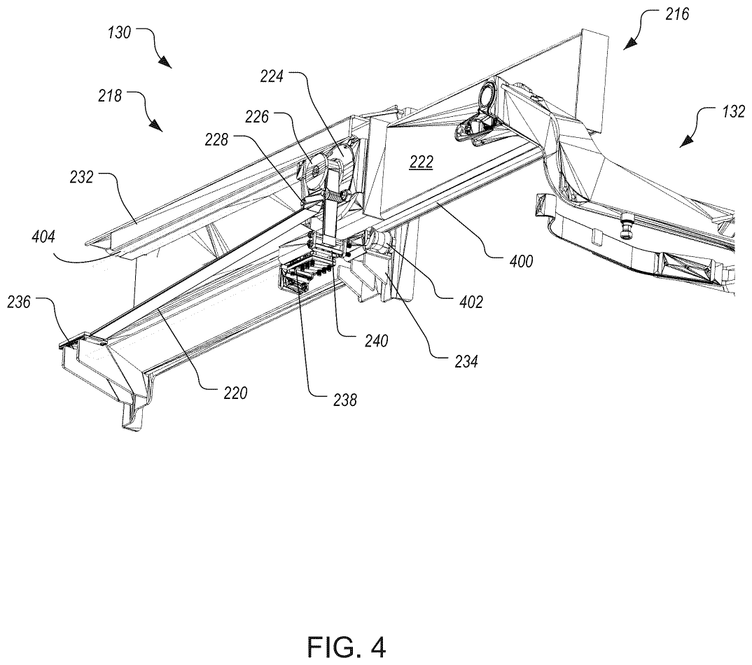

FIG. 4 is a perspective view from below illustrating a refuse loading mechanism according to some implementations. Slider assembly 216 is supported in guide assembly 218. Slider assembly 216 includes lower track 400. Lower track 400 is attached to the bottom of slider beam 222. In the example shown in FIG. 4, lower track 400 is in the form of a “V”. Slider assembly 216 is supported on lower support device 234. Lower support device 234 includes rollers 402. Rollers 402 have a V groove that is complementary to the shape of lower track 400. As slider beam 222 moves in and out, rollers 402 engage lower track 400 and support slider assembly 216 on guide assembly 218. Rollers 402 can include bearings.

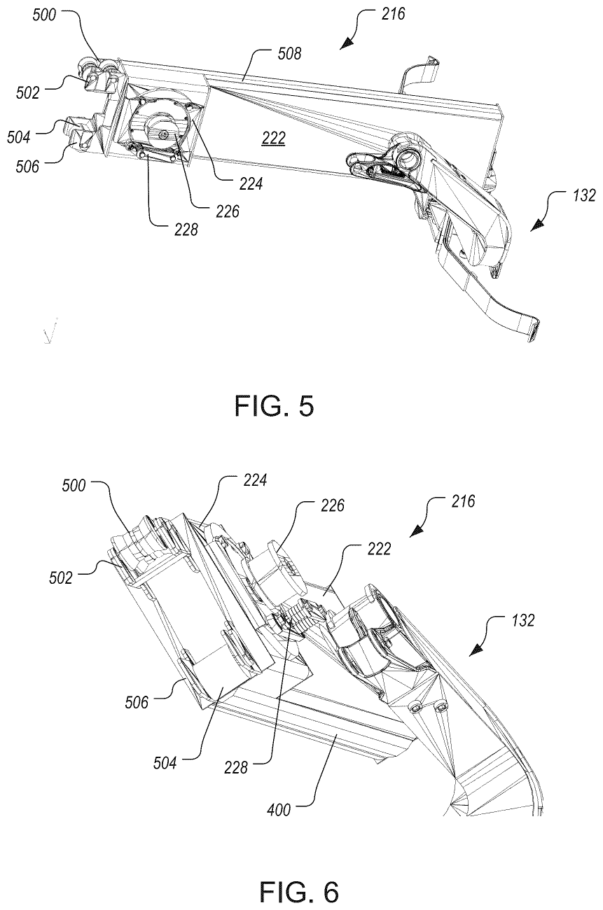

Upper rail assembly 232 includes an upper track 404. Upper track 404 is located on the bottom of upper rail assembly 232. Slider assembly 216 can include rollers (e.g., rollers 500 shown and described below relative to FIG. 5). As slider beam 222 moves in and out, the rollers on slider assembly 216 can roll on upper track 404. The upper and lower rollers can cooperate to support the cantilevered load of slider assembly 216, including the weight of slide beam 222 and grabber device 132.

FIG. 5 is a perspective view illustrating a slider assembly according to some implementations. In this example, slider assembly 216 includes upper rollers 500, upper clevis 502, lower roller 504, and lower clevis 506. Upper clevis 502 and lower clevis 504 are mounted on body 508 of slider beam 222. Upper rollers 500 are mounted on upper clevis 502. Lower roller 504 is mounted on lower clevis 506. Upper rollers 500 can engage on upper track 404 described above relative to FIG. 4.

FIG. 6 is a rear view of a slider assembly the slider assembly shown in FIG. 5. In the example shown in FIG. 6, lower track 400 is on the bottom of the slider beam and extends the length of the slider beam and has a V-shape. A track can be in other locations (such as on the side or top of the slider beam) or have other shapes (such as curved or rectangular).

In some implementations, a refuse loading mechanism includes a braking device. The braking device can be used to stop or inhibit motion of a reciprocating member, such as slider beam 220. The braking device can be operably coupled to a control unit, such as control unit 206 described above relative to FIG. 2. In one implementation, a braking device is provided at the location of roller 504.

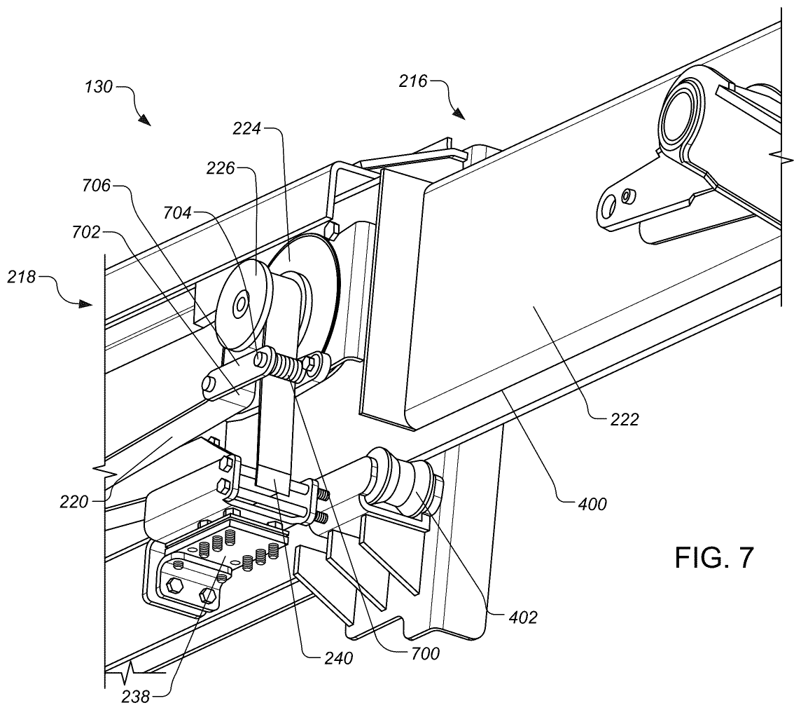

FIG. 7 illustrates is a detail view illustrating drive unit and drive pulley with the slider assembly in an extended position. Drive pulley 226 is attached to an electric motor in drive unit 224. Idler assembly 228 is coupled on the front of a housing assembly for drive unit 224. Idler assembly 228 includes mounting bracket 700, street-side idler pulley 702, curb-side idler pulley 704, and connecting member 706. Street-side idler pulley 702 and curb-side idler pulley 704 cooperate to maintain belt 220 in engagement with drive pulley 226.

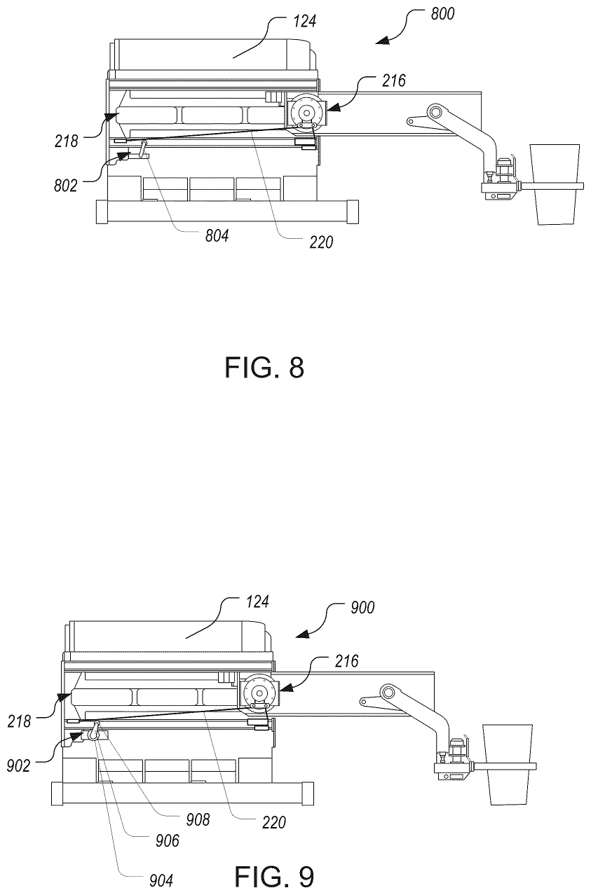

Belt tensioning device 240 can be used to adjust tension on belt 220. In some implementations, belt tensioning device 240 includes tension adjustment rods that can be positioned. A tensioner can be mounted at either end of belt (e.g., proximal or distal). The tensioner can be vertically mounted, horizontally mounted, or at other angles. In one implementation, the belt tensioning device is a heavy-duty belt tensioner with a tension arm and an idler shaft. The tensioner maintains the idler in contact with the belt. Rollers on the drive unit can engage the belt to keep it wrapped around the drive pulley. FIG. 8 illustrates a tensioning device according to implementations. Refuse loading mechanism 800 includes slider assembly 216, guide assembly 218, belt 220, and tensioner 802. The angle of tension arm 804 of tensioner 802 can be adjusted to change tension on belt 220. In one case, the tension arm is about 5 inches.

In some implementations, the tensioner can include a base, an arm coupled to the base that can be pivoted with respect to the base, and an idler coupled at the end of the arm. FIG. 9 illustrates another example of a tensioning device. Refuse loading mechanism 900 includes slider assembly 216, guide assembly 218, belt 220, and tensioner 902. Tensioner 902 includes base 904, tension arm 906, and idler 908. In some implementations, the tensioner is an automotive-style belt tensioner.

In some implementations, the drive unit rollers are used to adjust belt tension. Adjustments to tension can be made manually, automatically, or a combination thereof. In some implementations, the axes of the a pair of idler rollers (e.g., street-side idler pulley 702, curb-side idler pulley 704) are drawn toward one another to increase tension on the belt. Conversely, the pair of idler rollers can be spread apart from one another to decrease tension. A tensioner can be actuated manually, automatically, or a combination thereof. A tensioner can be actuated electrically (e.g., by a motor or linear actuator), mechanically, hydraulically, or pneumatically, or other manner.)

Curb-side attachment device 238 is used to secure the curb-side end of belt 220. In the example, includes a pair of plates between which the end of the belt can be sandwiched and bolted down. A similar arrangement can be used on the street-side attachment device.

In combination with lower rollers 402, upper rollers 500 can bear the cantilevered load of slider assembly 216. The cantilevered load includes the loads of portion of the slider beam that extends beyond the rollers, the grabber device, and any residential sized container that is picked up from time to time by the grabber device.

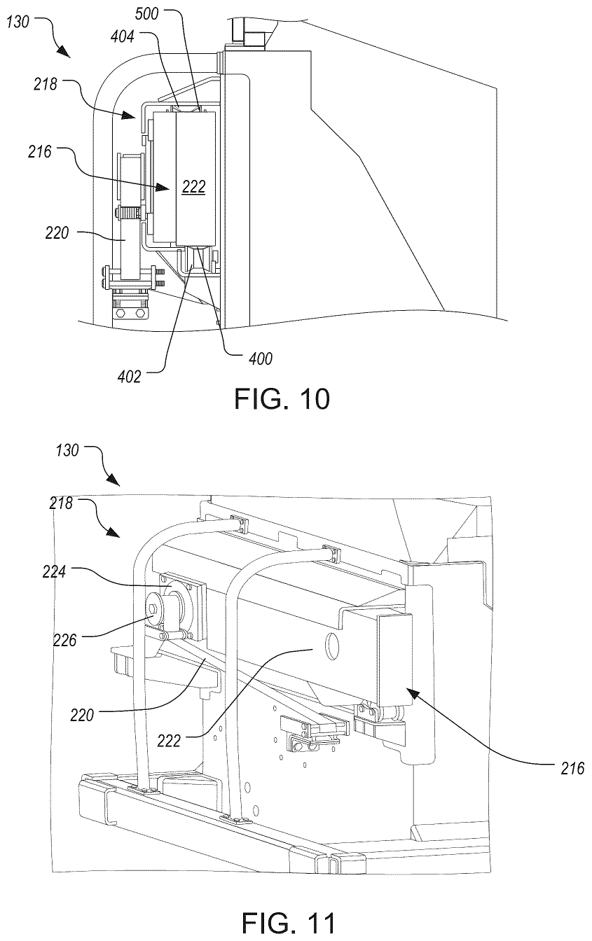

FIG. 10 is an end view of the refuse loading mechanism illustrating engagement of the upper and lower rollers on their corresponding tracks. During extension and retraction, upper rollers 500 roll on upper track 404, and rollers 402 roll on lower track 400.

FIG. 11 illustrates a slider assembly in a retracted position in a guide assembly (the grabber device and associated lift arm have been omitted from FIG. 11 for clarity). In the illustration of FIG. 11, slider assembly 216 is retracted toward the street side of the mechanism. As slider beam 222 is retracted to the position shown in FIG. 11, idler assembly 228 maintains belt 220 in engagement on drive pulley 226.

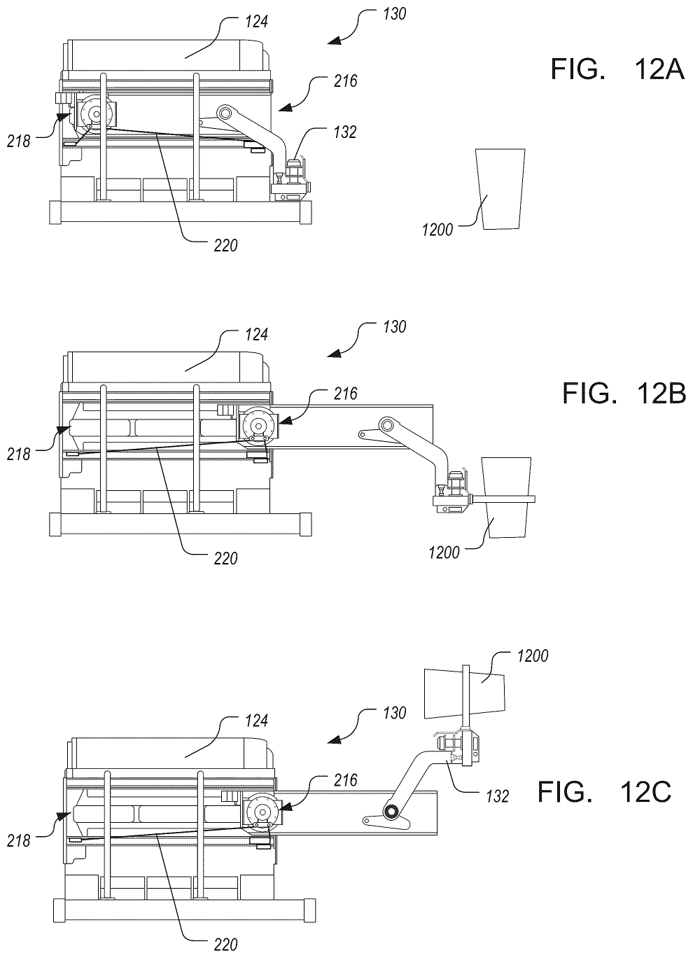

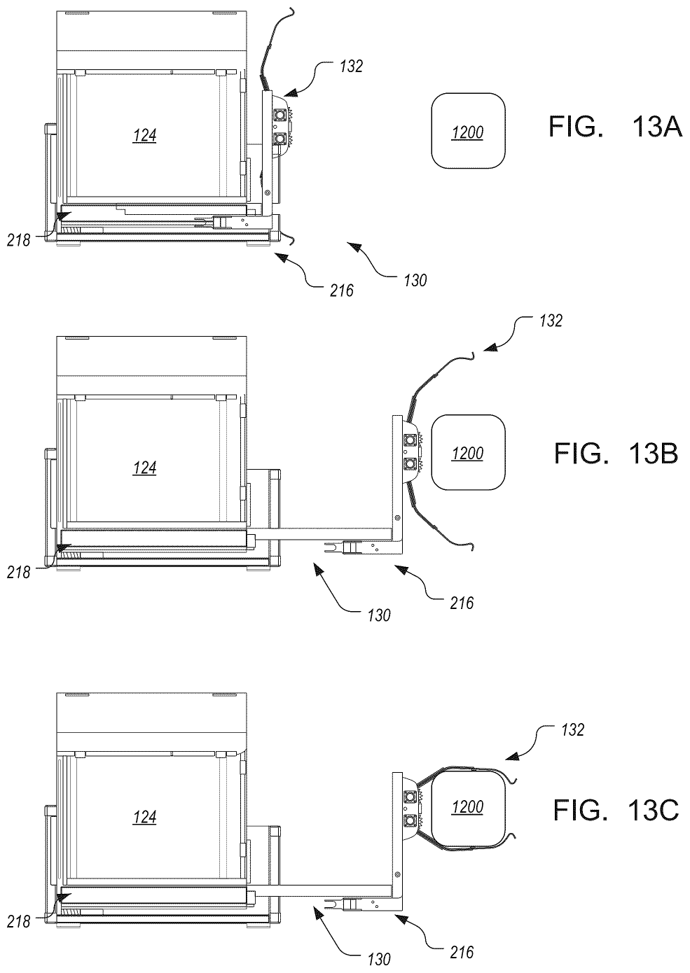

FIGS. 12A-12C are rear views of a refuse collection system illustrating use of the refuse collection system to collect refuse from a curb-side container. Initially, slider assembly 216 is in a retracted position on guide assembly 218. (FIG. 12A). Refuse collection mechanism 130 can be operated to extend slider assembly to an extended position relative to intermediate container 124 and the vehicle to which the collection system is attached. To extend slider assembly 216, drive unit 224 is operated to turn drive pulley 226 on belt 220.

Grabber device 132 can be operated to grab the curb-side container 1200 (FIG. 12B). Grabber device 132 can be operated (for example, by rotating arm 300 up on slider beam 222) to lift container 1200 so that the contents of container 1200 can be emptied into intermediate container 124. (FIG. 12C).

FIGS. 13A-13C are top views of a refuse collection system illustrating use of the refuse collection system to grab a curb-side container. Initially, slider assembly 216 is in a retracted position on guide assembly 218. (FIG. 13A). Refuse collection mechanism 130 can be operated to extend slider assembly to an extended position relative to intermediate container 124 and the vehicle to which the collection system is attached. To extend slider assembly 216, drive unit 224 (shown in FIG. 12A) is operated to turn drive pulley 226 (shown in FIG. 12A) on belt 220 (shown in FIG. 12A). Grabber device 132 can be operated to close arms 304 of grabber device 132. (FIG. 13B). Grabber device 132 can be operated to close arms 304 until grabber device 132 is holding curb-side container 1000 (FIG. 13C).

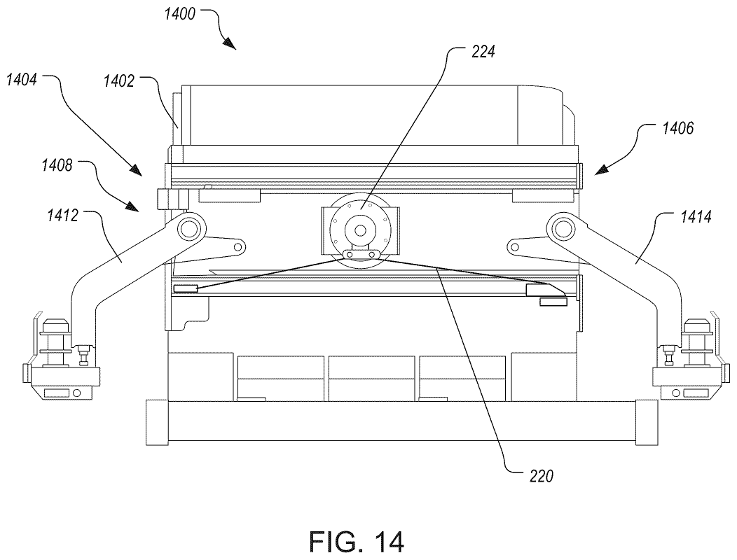

In various implementations described above, a refuse collection system includes a refuse loading mechanism that picks up refuse containers on one side of a vehicle. In some implementations, however, a refuse collection system includes a refuse loading mechanism that can pick up refuse on both sides a vehicle. FIG. 14 illustrates a refuse loading mechanism that can load refuse on either side of a vehicle. The refuse loading mechanism can be operated to extend a grabbing device on either side vehicle. Refuse collection system 1200 includes container 1402, refuse loading mechanism 1404. Refuse loading mechanism includes slider assembly 1206, guide assembly 1408, belt 220, and grabber devices 1412, 1414. Drive unit 224 can be operated rotate a drive pulley coupled to drive unit 224 to alternatively extend grabber device 1412 or grabber device 1414 (for example, on the street-side and curb-side of a refuse collection vehicle).

In the system illustrated in FIG. 14, the drive unit can be operated to move the slider beam to alternately position a curb-side grabbing device and a street-side grabbing device. In another implementation, a refuse collection system includes a mechanism for positioning a single grabber device on either side of a refuse collection vehicle, such as by way of a slide rail or a swinging arm coupled to a reciprocating member. In still another implementation, a refuse loading mechanism is mounted in front of an intermediate container. (Such a mechanism can be mirrored relative to what is shown in FIGS. 13A-13C such that the mechanism still loads on the curb-side of the vehicle.)

In various implementations described above, a rotatable element on a reciprocating assembly is driven on a flexible member (e.g., a belt), with fixed ends to move the reciprocating member to position a refuse-loading device. A rotatable element can be driven on a flexible member fixed ends to effect other processes on a refuse collection vehicle. A rotatable element can be moved on a flexible member to effect linear motion in other mechanisms, such as to pack refuse in, or eject refuse from, a container of a vehicle. As other examples, in some implementations, a rotatable element can be moved on a flexible member to lift refuse out of a container in a refuse collection vehicle, or to move refuse from one location to another in the refuse collection vehicle.

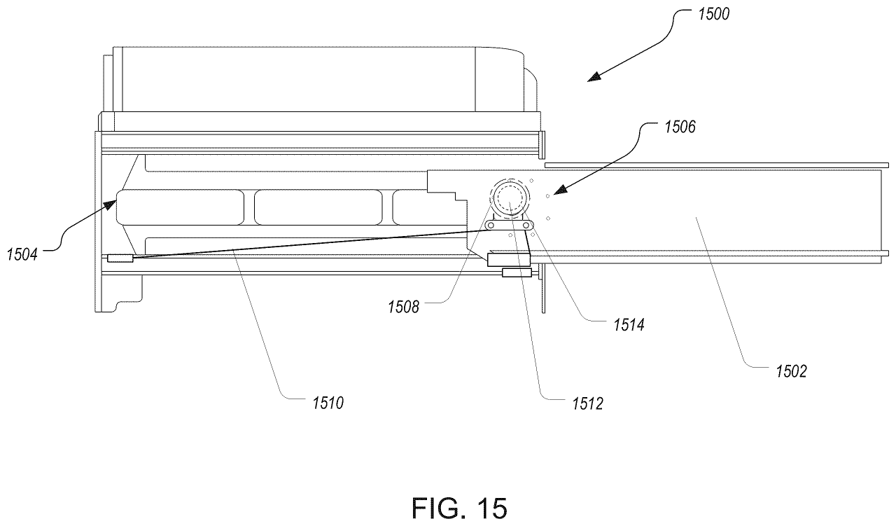

In the example shown in FIG. 7, a rotating assembly includes a drive pulley that can be mounted to a motor drive shaft of the drive unit. A loading mechanism can, in other implementations, include other drive unit arrangements that turn to drive the loading mechanism. In some implementations, a drive unit of the packing device includes an outrunner/hub motor arrangement. In this implementation, the rotor of the electric motor is positioned outside the stator. FIG. 15 schematically illustrates a refuse loading mechanism having an outrunner/hub motor arrangement according to some implementations. Refuse loading mechanism 1500 includes reciprocating member 1502, guide assembly 1504, electric motor assembly 1506, drive pulley 1508 and belt 1510. Electric motor assembly 1506 is coupled to reciprocating member 1502. Electric motor assembly 1506 includes stator unit 1512 and shell 1514. Shell 1514 can rotate around stator unit 1514. Drive pulley 1508 is coupled to shell 1514. Electric motor assembly 1506 can be operated to turn drive pulley 1508 such that drive pulley 1508 moves along belt 1510 to move reciprocating member 1502 in or out on guide assembly 1504. In some implementations, drive pulley 1508 is installed over the top of shell 1514.

In some implementations, a shell of an outrunner motor as includes teeth, grooves, or other features on the outer surface of the shell that directly engage on a belt. In this case, the drive pulley can be omitted.

In various implementations described above, a flexible member is attached at its ends below a reciprocating member (e.g., slider beam 222). In other implementations, the attachment locations for a flexible are above the reciprocating member. Arranging the attachment locations of a can, in some cases, improve access to the reciprocating member or other components of a mechanism.

Sensors can be included on various components of a refuse collection system, including, for example, a reciprocating member or a grabber device. A refuse collection system can include other sensors. For example, a refuse loading mechanism can include load sensors, position sensors, angle sensors, or pressure sensors. Operation of the refuse loading mechanism or other systems can be controlled based on the information provided by the sensors. In some implementations, a refuse collection system includes sensors to sense position, angle, load or other characteristics about the system. As an example, a sensor can sense position of a reciprocating member. As another example, a sensor can sense load imparted by a slider assembly (e.g., cantilevered load) on one or more structural elements of a guide assembly or container.

Control of a refuse collection device may be carried out manually, automatically, or a combination thereof. In some implementations, a control system collects data from refuse collection system sensors and/or other operational sensors and controls the refuse collection system or other components of vehicle based on the information. For example, a control system may automatically shut down or reduce the speed of a drive system if a compression load (or another measured characteristic of the refuse vehicle's system) is outside an established range or exceeds an established threshold.

In some implementations, torque, speed or other parameters are adjusted based on the position, load, or other characteristics of one or more members of a refuse loading mechanism. For example, in certain implementations, the torque of the motor, energy consumption, or other operating parameters are adjusted to account for different loads. Operation of loading mechanism for collecting recycled material can, for example, be different than operation of the loading mechanism for collecting trash. In some implementations, the rate of motion of the reciprocating member can be controlled. The control unit can implement optimized current curves for battery life vs. power, feedback control for heavy vs. light loads, etc. In some implementations, the control system coordinates motion between in/out motor and grabber/lift motor(s).

In some implementations, a system includes interlocks to prevent unintended or un-commanded movement (e.g., operating lift/grabber with beam in parked position).

In some implementations, the control system receives position feedback from motor movement (e.g., using a sensored motor in time with the belt, position of in/out can be determined mathematically from rotation/partial rotation of motor and belt pitch).

In some implementations, belt slip is monitored. In one example, belt slip is monitored using end-of-travel position/sensors.

In various implementations described above, devices are powered electrically. In certain implementations, however, devices used to operate components of a mechanism a refuse loading mechanism (such as a grabber device lift arm, or a reciprocating member) can be activated or powered in other manners, such as pneumatically, mechanically, or hydraulically.

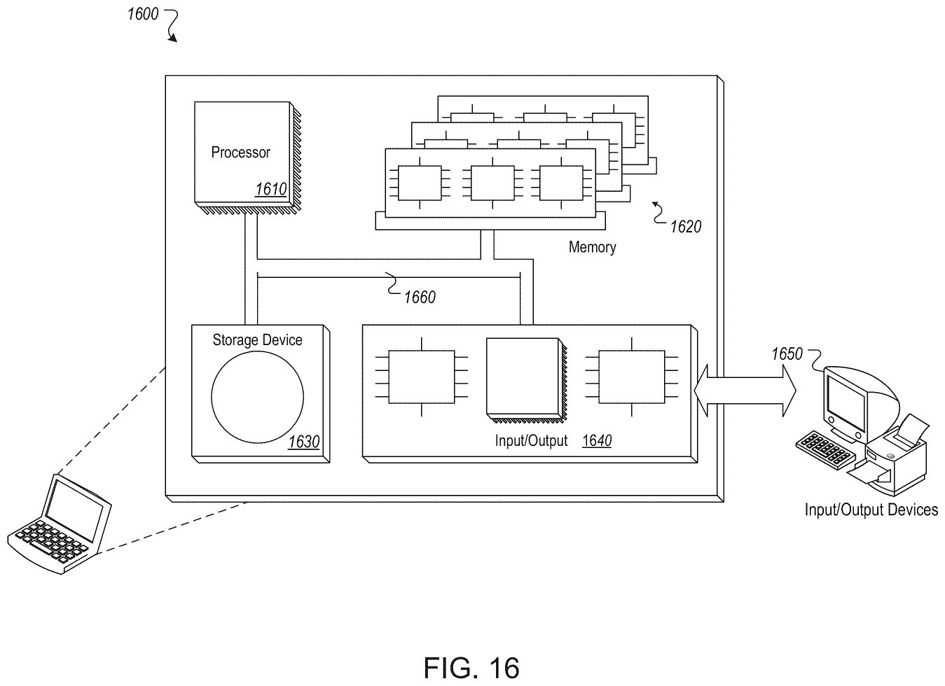

Control units and/or computing devices as described herein can include or use one or more computing systems. FIG. 16 depicts an example computing system, according to implementations of the present disclosure. The system 1600 may be used for any of the operations described with respect to the various implementations discussed herein. The system 1600 may include one or more processors 1610, a memory 1620, one or more storage devices 1630, and one or more input/output (I/O) devices 1650 controllable via one or more I/O interfaces 1640. The various components 1610, 1620, 1630, 1640, or 1650 may be interconnected via at least one system bus 1660, which may enable the transfer of data between the various modules and components of the system 1600. In some implementations, a control system may be coupled to an operator display and control panel (for example, located in a cab of the vehicle.)

The processor(s) 1610 may be configured to process instructions for execution within the system 1600. The processor(s) 1610 may include single-threaded processor(s), multi-threaded processor(s), or both. The processor(s) 1610 may be configured to process instructions stored in the memory 1620 or on the storage device(s) 1630. For example, the processor(s) 1610 may execute instructions for the various software module(s) described herein. The processor(s) 1610 may include hardware-based processor(s) each including one or more cores. The processor(s) 1610 may include general purpose processor(s), special purpose processor(s), or both.

The memory 1620 may store information within the system 1600. In some implementations, the memory 1620 includes one or more computer-readable media. The memory 1620 may include any number of volatile memory units, any number of non-volatile memory units, or both volatile and non-volatile memory units. The memory 1620 may include read-only memory, random access memory, or both. In some examples, the memory 1620 may be employed as active or physical memory by one or more executing software modules.

The storage device(s) 1630 may be configured to provide (e.g., persistent) mass storage for the system 1600. In some implementations, the storage device(s) 1630 may include one or more computer-readable media. One or both of the memory 1620 or the storage device(s) 1330 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 1600. In some implementations, the CRSM may include a data store that provides storage of computer-readable instructions or other information in a non-transitory format. The CRSM may be incorporated into the system 1600 or may be external with respect to the system 1600. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 1610 and the memory 1620 may be supplemented by, or incorporated into, one or more application-specific integrated circuits (ASICs). The system 1600 may include one or more I/O devices 1650.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

In various implementations described above, refuse loading mechanisms have been described for use on a residential front-loader. Implementations can, however, be employed with respect to any suitable type of RCV, with any suitable type of body and/or hopper variants. For example, the RCV can be an automated side loader vehicle. As another example, the RCV can be a commercial front loader (e.g., for dumpster type containers). A front loader can be provided with or without an intermediate collection device.

As used herein, a “drive unit” includes any device, mechanism, or system that imparts force to mechanically drive one or more components. Examples of a drive unit include a hydraulic motor, an electric motor, or an engine. A driver may also include gearboxes, belts, cables, chain drives, or other power transmission devices.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claim(s).

1. A refuse collection system, comprising:
a refuse-receiving container; and
a refuse loading mechanism coupled to the refuse-receiving container and configured to transfer refuse into the refuse-receiving container, the refuse loading mechanism comprising:
a guide assembly;
a flexible member coupled to the guide assembly at a first location and a second location;
a reciprocating member configured to translate relative to the guide assembly;
a rotatable element coupled to the reciprocating member and engaged with the flexible member, and
a drive unit configured to turn the rotatable element on the flexible member such that the reciprocating member translates on the guide assembly.

2. The refuse collection system of claim 1, further comprising a grabber device coupled to the reciprocating member.

3. The refuse collection system of claim 1, wherein the drive unit is configured to move the reciprocating member between an retracted position and at least one other position.

4. The refuse collection system of claim 1, wherein the drive unit comprises an electric motor.

5. The refuse collection system of claim 1, wherein the drive unit comprises a hydraulic motor.

6. The refuse collection system of claim 1, wherein the reciprocating member comprises a slide member configured to move in and out relative to the guide assembly.

7. The refuse collection system of claim 1, wherein the flexible member comprises a belt.

8. The refuse collection system of claim 1, wherein the flexible member comprises a belt, wherein the rotatable element is configured to engage the belt.

9. The refuse collection system of claim 1, wherein the rotatable element comprises two or more teeth configured to engage the flexible member.

10. The refuse collection system of claim 1, wherein:
the guide assembly comprises one or more tracks; and
the reciprocating member comprises a slider beam configured to translate on the track.

11. The refuse collection system of claim 1, wherein:
the guide assembly comprises one or more rollers, and
the reciprocating member is configured to translate on at least one of the one or more rollers.

12. The refuse collection system of claim 1, further comprising one or more guides configured to guide the flexible member.

13. The refuse collection system of claim 1, wherein the one or more guides comprise one or more idlers, wherein the idlers are configured to guide the flexible member to promote engagement of the belt with the rotatable element.

14. The refuse collection system of claim 1, wherein the one or more guides comprises a first guide configured to engage the flexible member on one side of the rotatable element and a second guide configured to engage the flexible member on the other side of the rotatable element.

15. The refuse collection system of claim 13, wherein at least one of the one or more guides comprises a tensioning device.

16. The refuse collection system of claim 1, further comprising one or more tensioning devices configurable to alter tension on the flexible member.

17. The refuse collection system of claim 1, wherein the reciprocating member is configured to translate on the guide assembly such that the rotatable element travels along the guide assembly at least a portion of the way between an extended position and a retracted position.

18. The refuse collection system of claim 1, further comprising a grabber device coupled to the reciprocating member and comprising one or more arms operable to couple with a curbside container.

19. The refuse collection system of claim 1, further comprising a grabber device coupled to the reciprocating member and comprising one or more electric motors operable to engage one or more arms of the grabber device with a curb-side container.

20. The refuse collection system of claim 1, further comprising an arm coupled to the reciprocating member and operable to lift refuse toward an opening in the refuse-receiving container.

21. The refuse collection system of claim 1, further comprising:
a refuse collection vehicle to which the refuse-receiving container and the refuse loading mechanism are coupled; and
one or more grabber devices coupled to the reciprocating member,
wherein the one or more grabber devices are operable to collect refuse on both sides of the vehicle.

22. The refuse collection system of claim 1, wherein the guide assembly comprises an upper rail and a lower support element, wherein the upper rail and the lower support element cooperate to support an overhanging load on the guide assembly.

23. The refuse collection system of claim 1, wherein:
the guide assembly comprises:
an upper track; and
a lower support element comprising one or more lower rollers,
the slide assembly comprises:
one or more upper rollers; and
a lower track; and
the upper rollers roll on the upper rail and the lower rollers roll on the lower track when the slide assembly translates on the guide assembly.

24. The refuse collection system of claim 1, further comprising a control unit configured to operate the drive unit to move to the slider assembly in and out on the guide assembly.

25. The refuse collection system of claim 1, wherein:
the drive unit comprises an outrunner/hub motor system; and
the outrunner/hub motor system is configured to turn the rotatable element on the flexible member such that the reciprocating member translates on the guide assembly.

26. A refuse collection system, comprising:
a vehicle;
a refuse handling mechanism coupled to the vehicle and configured to handle refuse on or in the vehicle, the refuse handling mechanism comprising:
a guide assembly;
a flexible member coupled to the guide assembly at a first location and a second location;
a reciprocating member configured to translate relative to the guide assembly; and
a rotatable element coupled to the reciprocating member and engaged with the flexible member, and
a drive unit configured to turn the rotatable element on the flexible member such that the reciprocating member translates on the guide assembly.

27. The refuse collection system of claim 26, wherein the refuse handling mechanism is configured to load refuse onto or into the vehicle.

28. The refuse collection system of claim 26, wherein the refuse handling mechanism is configured to move refuse from one location on the vehicle to another location on the vehicle.

29. The refuse collection system of claim 26, wherein the refuse handling mechanism is configured to eject refuse from the vehicle.

30. The refuse collection system of claim 26, wherein the refuse handling mechanism is configured to compact refuse on the vehicle.

31. The refuse collection system of claim 26, wherein:
the flexible member is coupled to the guide assembly at a first location and a second location; and
the rotatable element is movable on the flexible member between the first location and the second location.

32. The refuse collection system of claim 26, wherein the drive unit comprises an electric motor.

33. The refuse collection system of claim 26, wherein the flexible member comprises a belt.

34. A method of handling refuse on a refuse collection vehicle, comprising:
turning a rotatable element engaged with a flexible member that is coupled to a guide assembly such that the reciprocating member translates relative to the guide assembly; and
operating a refuse handling device coupled to the reciprocating member to handle refuse.

35. The method of claim 34, wherein turning a rotatable element comprises drawing the reciprocating member from a retracted position on a refuse collection vehicle to an extended position on the refuse collection vehicle.

36. The method of claim 34, wherein turning a rotatable element comprises drawing the reciprocating member from an extended position on a refuse collection vehicle to a retracted position on the refuse collection vehicle.

37. The method of claim 34, further comprising:
maintaining a first portion of the flexible member at a first location relative to the guide assembly; and
maintaining a second portion of the flexible member at a second location relative to the guide assembly.

38. The method of claim 34, wherein:
the flexible member is coupled to the guide assembly at a first location and a second location, and
turning the rotatable element comprises moving the rotatable element along the flexible member between the first location and the second location.

39. The method of claim 34, wherein operating the refuse handling device comprises loading refuse into or onto the refuse collection vehicle.

40. The method of claim 34, wherein operating the refuse handling device comprises loading refuse from a curb-side container into a refuse-receiving container.

41. The method of claim 40, further comprising moving refuse from the refuse-receiving container into another container on the refuse collection vehicle.

42. The method of claim 34, wherein operating the refuse handling device to handle refuse comprises moving refuse from one location on the vehicle to another location on the vehicle.

43. The method of claim 34, wherein operating the refuse handling device to handle refuse comprises ejecting refuse from the vehicle.

44. The method of claim 34, wherein operating the refuse handling device to handle refuse comprises compacting refuse on the vehicle.
